(19) United States
(12) Patent Application Publication
(10) Pub. No.: US 2004/0149895 A1
(43) Pub. Date: Aug. 5, 2004

(54) Electronic automobile transceiver device

(76) Inventors: Pinchas Agranti, Ramle (IL); Eli Flaxer, Tel Aviv (IL)

Correspondence Address: BRUCE E. LILLING, LILLING & LILLING P.C., P.O. BOX 560, GOLDEN BRIDGE, NY, 10526, US

(21) Appl. No.: 10/481,738

(22) PCT Filed: Jun. 23, 2002
(86) PCT No.: PCT/IL02/00498

(30) Foreign Application Priority Data
Jun. 25, 2001 (IL) 143964

(51) Int. Cl. G06M 7/00

(52) U.S. Cl. 250/221

(57) ABSTRACT

An electronic transceiver useful in automatically switching a blinding headlight high beam to a low beam setting, comprising a) a first sensor capable of detecting specifically an oncoming or following headlight's high beam; b) a transmitter useful in transmitting a signal directed to change a high beam to the low beam setting; c) a second sensor capable of receiving the signal of b); and d) a converter capable of converting the received signal to the action of changing the headlight mode.

### FIELD OF THE INVENTION

The field of the invention is communication between vehicles.

### BACKGROUND OF THE INVENTION

A well-known danger of night driving is when two vehicles are approaching each ther from opposite directions and one (or both) vehicles have their high-beam headlights on, rather than the low beam. In this situation, the driver of opposite the vehicle with the high beam may be blinded, and the chance of an accident occurring greatly increases. According to traffic regulations, the meeting of vehicles at night requires that the front headlight lamp must be at the low beam setting.

CN 1047055A relates to a control device for the automatic beam change of an automobile's front headlight lamp. According to the publication of its abstract, the control device is used to control the front lamp of any vehicle within a defined radius, and not only that of the approaching vehicle. Said device automatically accomplishes the stated function. This capability is how it differs from existing built-in devices for headlight beam setting and control. On each vehicle a signal wave transmitting device is set. During night driving the signal wave is transmitted from each vehicle. The signal wave may be infrared ray, impulse infrared ray, ultra-short-wave radio wave, laser and ultrasonic wave, etc. As vehicles approach one another in the dark, a signal wave is received from the oncoming car and the high beam changes to a low beam automatically. After passing one another, the signal wave disappears and the beam will return to its former setting.

However, the CN 1047055A device as described in this publication is not sufficiently selective. According to this publication, the signal is automatically transmitted in a wide radius to change any vehicle's high beams to low beams. This can cause unnecessary changes of beam settings in vehicles other than those that are actually disturbing the driver with the transmitting device. Also, said publication fails to offer a solution to the problem of vehicles blinding from behind. It is to be noted that the CN 1047055A device does not react to high beam radiations. It reacts to every vehicle within its transmitting radius and then sends out its signal, whether the vehicle is driving with a high or low beam. The CN 1047055A device does not have any voice or text message transmitting capabilities between vehicles. Thus, the need for a more selective and sophisticated method of this kind remains.

Hence, it is a purpose of the present invention to provide an electronic system which controls the head lights of vehicles in a manner that reduces blinding from high beam head lights.

It is yet a further purpose of the present invention to provide such an electronic system, which overcomes the shortcomings of the prior art devices.

Other purposes of the invention shall become apparent as the description proceeds.

### SUMMARY OF THE INVENTION

The present invention relates to an electronic transceiver useful in automatically switching a blinding headlight high beam to a low beam setting, comprising

a) a first sensor capable of detecting specifically an oncoming or following headlight's high beam;

b) a transmitter useful in transmitting a signal directed to change a high beam to the low beam setting;

c) a second sensor capable of receiving the signal of b); and

d) a converter capable of converting the received signal to the action of changing the headlight mode.

According to one embodiment, the signal transmitted from the transmitter is selected from the group that consists of RF, optic or acoustic wave.

According to another aspect, the present invention further relates to an electronic transceiver useful in transmitting messages between vehicles. According to one embodiment said messages may be either voice activated or text messages.

According to a preferred embodiment, the first sensor, which is capable of detecting specifically an oncoming or following headlight's high beam, is not affected by other forms of light radiation like sunlight, street lamps or house lighting.

According to another embodiment, in a first stage a signal is transmitted from the vehicle being blinded by the high beam to the vehicle of the oncoming or following headlight's high beam to notify the driver of said vehicle that the high beam is blinding, optionally further notifying that in a short period of time the high beam will be changed to the low beam, and in a second stage, after a period of time, a signal is transmitted from the vehicle being blinded to the blinding vehicle in order to automatically change the high beam to the low beam; said period of time being typically between 1 and 20 seconds.

According to another embodiment, a signal is transmitted from the vehicle being blinded by the high beam to the vehicle of the oncoming or following headlight's high beam to inform the driver of said vehicle that the high beam is blinding.

### BRIEF DESCRIPTION OF THE DRAWING

FIG. 1 represents a schematic view of the transceiver of the present invention.

### DETAILED DESCRIPTION OF THE INVENTION

A primary feature of the present invention is a sensor in one car that will detect the high beam radiance from either an approaching or following vehicle and send a signal to that car and automatically lower its headlight beam setting. The signal may be transmitted via RF, optic or acoustic wave technology. The component's capacity to control headlight beams is automatically disabled during daylight. This device also offers a secondary option of transmitting either voice activated or text messages between vehicles.

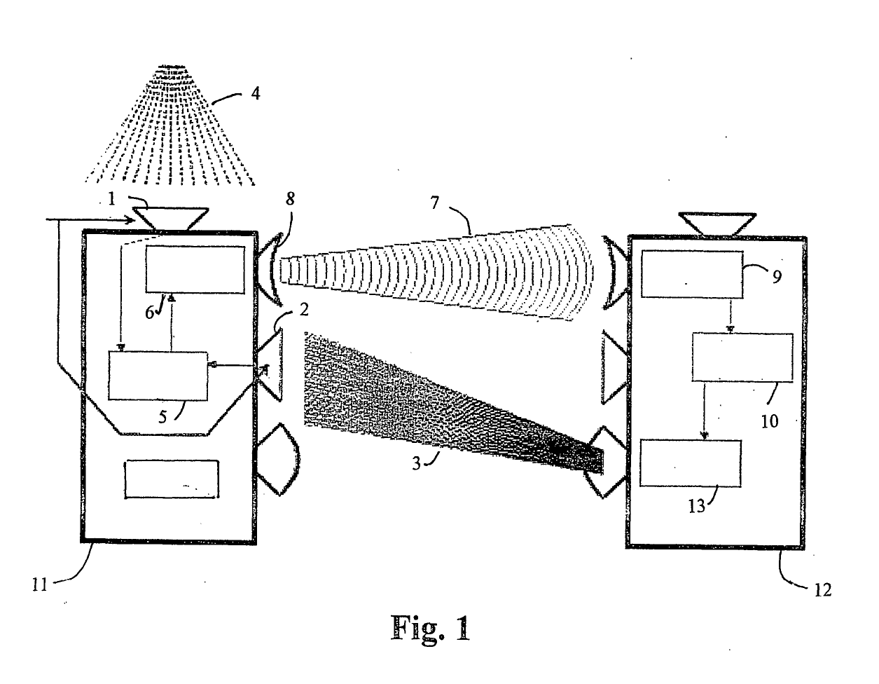

In FIG. 1, photo resistor type light sensors (numerals 1 and 2) of the first vehicle (11) simultaneously measure the light beam transmissions from the second vehicle (12) (whether it being oncoming vehicle or/and following vehicle) (3) as well as various sources of background light (4) such as street lamps and luminous signs. The logic control (5) determines if the headlight radiations are of the blinding, high beam variety. If they are, then the logic system controls a high frequency RF transmitter (6) and sends a directed encoded radio signal (7) via a suitable antenna (8). The transmitted signal covers a few hundred meters and is received by the second vehicle's RF receiver (9). This signal passes to the logic control (10) of the second vehicle, which activates an electronic relay (13) that automatically lowers the headlight beam (3) from the high to the low beam setting.

According to a particular embodiment of the present invention the sensing units (1) comprise of at least one photoresistor which is directed so that it is not effected by the lights of oncoming or following vehicles, e.g., upwards (hereinafter “background sensor”) so that it senses and measures the intensity of the background light from street lamps and other sources, and additional photoresistors (2) which are directed to sense and measure the intensity of the light of oncoming or following vehicles (hereinafter “primary sensors”). The intensity of the light measured by the background sensor is subtracted from the intensity of the light sensed by either of the primary sensor to provide a corrected intensity measurement, thus determining whether the light is blinding. Blinding light is defined when the corrected intensity is above a certain threshold intensity, which may be adjusted.

According to yet a further embodiment of the invention the control logic unit carries out a test to determine whether the low beam lights are functioning, before lowering the high beam lights. Said test is conducted without changing the light sensing and is important for instances in which one or both of the low beam lights have malfunctioned, hence rendering the vehicle without proper lighting. Only after the test has confirmed that the low beam lights are functional, is the light setting changed from the high beam setting to the low beam setting.

As seen in FIG. 1 the transceiver units in both the first car and in the second car comprise the same elements, thus the each of these transceiver units may be of the blinding car or of the blinded car.

Once it is determined that the sensed light is blinding, A microprocessor receives a signal indicating this and sends a signal via the UART to the RF transceiver (6). According to one embodiment such a microprocessor is a PIC16F877 (Control Logic) programmed in C program.

According to one embodiment the signal sent by the transceiver is not coded.

According to another embodiment the signal sent by the transceiver is coded.

According to this embodiment, the signal may contain messages other than of blinding light, such as messages referring to hazards, attacking, panic etc.

The option exists for a directed encoded radio signal to transfer either a text message or pre-recorded audio message between two vehicles. These optional text or voice messages would communicate to the driver receiving them by either a small screen or speaker. While the contents of said text or voice messages may vary in a wide scope, according to a preferred embodiment said text or voice messages relate to hazardous driving situations including, but not limited to, warning of blinding by high-beam headlights, “oil on the road”, “water on the road”, “object on the road”, “accident ahead” and “broken road ahead”, “do not tail tag”, or messages expressing a need for assistance—either technical, medical or other.

According to another embodiment, the present invention relates to an electronic receiver useful in automatically switching a blinding headlight high beam to a low beam setting, comprising

a) a sensor capable of detecting the signal of the flickering of an oncoming headlight's high beam;

b) a converter capable of converting the received signal to the action of changing the headlight mode.

According to this embodiment, it is sufficient for the driver of the blinded vehicle to flicker his headlights towards the oncoming blinding vehicle in order for the converter to automatically convert the headlight, residing in the oncoming blinding vehicle to convert the lights to the low beam setting.

While embodiments of the invention have been described by way of description, it will be apparent that the invention may be carried out with many modifications, variations and adaptations, without departing from its spirit or exceeding the scope of the claims. It should be understood that some modification, alteration and substitution is anticipated and expected from those skilled in the art without departing from the teachings of the invention. Accordingly, it is appropriate that the following claims be construed broadly and in a manner consistent with the scope and spirit of the invention.

1) An electronic transceiver useful in automatically switching a blinding headlight high beam to a low beam setting, comprising
a) a first sensor capable of detecting specifically an oncoming or following headlight's high beam;
b) a transmitter useful in transmitting a signal directed to change a high beam to the low beam setting;
c) a second sensor capable of receiving the signal of b); and
d) a converter capable of converting the received signal to the action of changing the headlight mode.

2) An electronic transceiver according to claim 1 in which the signal transmitted from the transmitter is selected from the group that consists of RF optic or acoustic wave.

3) An electronic transceiver according to claim 1 wherein in a first stage a signal is transmitted from the vehicle being blinded by the high beam to the vehicle of the oncoming or following headlight's high beam to notify the driver of said vehicle that the high beam is blinding.

4) An electronic transceiver according to claim 1 wherein in a first stage a signal is transmitted from the vehicle being blinded by the high beam to the vehicle of the oncoming or following headlight's high beam to notify the driver of said vehicle that the high beam is blinding, further notifying that in a short period of time the high beam will be changed to the low beam, and in a second stage, after a period of time, a signal is transmitted from the vehicle being blinded to the blinding vehicle in order to automatically change the high beam to the low beam; said period of time being between 1 and 20 seconds.

5) An electronic transceiver according to claim 1 wherein the control logic unit further carries out a test to determine whether the low beam lights are functioning, before lowering the high beam lights; only after the test has confirmed that the low beam lights are functional, is the light setting changed from the high beam setting to the low beam setting.

6) An electronic transceiver useful in transmitting messages between vehicles, in which said messages are voice activated or text messages.

7) An electronic transceiver according to claim 6 which contains hazard related messages.

8) An electronic transceiver according to claim 6 which contains hazard related messages selected from hazardous driving situations, warning of blinding by high-beam headlights, “oil on the road”, “water on the road”, “object on the road”, “accident ahead” and “broken road ahead”, “do not tail tag” or messages expressing a need for technical assistance, medical assistance or other assistance.

9) An electronic transceiver according to claim 6 wherein the signal sent by the transceiver is not coded.

10) An electronic transceiver according to claim 6 wherein the signal sent by the transceiver is coded.

11) An electronic receiver useful in automatically switching a blinding headlight high beam to a low beam setting, comprising
a) a sensor capable of detecting the signal of the flickering of an oncoming or following headlight's high beam;
b) a converter capable of converting the received signal to the action of changing the headlight mode.
